(19) United States
(12) Patent Application Publication
(10) Pub. No.: US 2005/0230531 A1
(43) Pub. Date: Oct. 20, 2005

(54) Variable forward swept wing supersonic aircraft having both low-boom characteristics and low-drag characteristics

(75) Inventor: Shigeru Horinouchi, Tokyo (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: JAPAN AEROSPACE EXPLORATION AGENCY, Tokyo (JP)

(21) Appl. No.: 11/103,549

(22) Filed: Apr. 12, 2005

(30) Foreign Application Priority Data
Apr. 13, 2004 (JP) 2004-118240

(51) Int. Cl. B64C 3/40

(52) U.S. Cl. 244/47

(57) ABSTRACT

It is an object of the present invention to provide the entire airplane shape of a supersonic aircraft that can realize low sonic boom characteristics, and that can also minimize wave-drag. In order to achieve both sonic boom suppression and a reduction in wave-drag, the entire airplane shape of the supersonic aircraft of the present invention uses a variable forward swept wing configuration having a mechanism that can vary a forward sweep angle as the main wing configuration, rather than forming the fuselage shape with a blunt nose.

### BACKGROUND OF THE INVENTION

1. Field of the Invention

The present invention relates the entire airplane shape of a supersonic aircraft, and more specifically relates to an entire airplane shape that reduces wave-forming drag, and suppresses sonic booms.

2. Description of the Related Art

Generally, in order to satisfy requirements from the standpoints of both economy and environmental compatibility, it is necessary that supersonic aircraft reduce the wave-drag force arising from shock waves, and suppress sonic booms. In the basic approach to reducing wave-drag of a body performing supersonic flight, increasing the slenderness ratio in a case where this body is converted into an equivalent axisymmetrical body is the first condition. As is shown in FIG. 12, this equivalent axisymmetrical body is an equivalent rotational body which has the same cross-sectional area as the cross-sectional area in a case where a certain body position of the aircraft is cut by the Mach plane determined by the flight Mach number (a plane whose normal vector is inclined by an angle of μ=sin−1(1/M) with respect to the axis of the fuselage). Designing an extremely slender aircraft body or reducing the size of the main wing is an effective means of increasing the slenderness ratio.

The next shape with a minimal wave-drag force that is to be considered is known to be an axisymmetrical body shape called the Sears-Haack body, as shown in FIG. 13 (see Sears, W. R., “On Projectiles of Minimum Wave Drag”, Quart. Appl. Math. Vol. 14, 1947). The wave-drag force of a supersonic aircraft can be reduced by making the cross-sectional area distribution of this aircraft equivalent to the cross-sectional area distribution of a Sears-Haack body in addition to increasing the slenderness ratio. Such an aircraft design procedure is called area rule design. This figure is shown as a figure illustrating a comparison of the cross-sectional area distribution of a Sears-Haack body in which the wave-drag force is minimized, and the cross-sectional area of an actual aircraft.

Methods for suppressing sonic booms have been studied over a long period of time; the most influential method of this type is a method in which the intensity of the sonic boom on the ground is reduced by forming the aircraft body shape so that the shock wave generation pattern is altered. As is shown in FIG. 14, the shock waves that are generated from the respective parts of the body of an ordinary supersonic aircraft are unified into two intense shock waves at the nose and tail of the aircraft in the process of being propagated through the atmosphere, so that these shock waves are observed on the ground as an N type pressure signature accompanied by two large pressure elevations. This figure illustrates the paradox of low sonic boom design and area rule design. The abovementioned sonic boom reduction method is a method that forms a low sonic boom pressure waveform that is not an N type waveform by correcting the aircraft body shape so that the unification of the shock waves is suppressed. In a paper (Seebass, A. R. and George, A. R., “Design and Operation of Aircraft to Minimize Their Sonic Boom”, Journal of Aircraft, Vol. 11, No. 9, pp. 509-517, 1974), George and Seebass indicated the sum of the equivalent cross-sectional area distribution determined from the cross-sectional area distribution and lift distribution of an aircraft forming a low sonic boom pressure waveform. Darden has proposed a procedure and program for the automatic determination of the cross-sectional area distribution of George and Seebass in “Sonic-Boom Minimization With Nose-Bluntness Relaxation.” NASA TP-1348, 1979.

However, an aircraft entire airplane shape that achieves both the abovementioned area rule design and the abovementioned low sonic boom design cannot be found, and there have been problems in the development of low-boom supersonic aircraft.

### SUMMARY OF THE INVENTION

It is an object of the present invention to provide a supersonic aircraft entire airplane shape which realizes low-boom characteristics, and which also minimizes wave-drag.

In order to make it possible to achieve both sonic boom suppression and a reduction in wave-drag, the supersonic aircraft entire airplane shape of the present invention does not use a blunt nosed body shape, but rather employs a variable forward swept wing configuration which has a mechanism that makes it possible to vary the forward sweep angle as the main wing configuration.

Since the supersonic aircraft entire airplane shape of the present invention employs a variable forward swept wing configuration equipped with a mechanism that makes it possible to vary the forward sweep angle as the main wing configuration, the forward sweep angle can be reduced to optimize performance during takeoff and landing, and during subsonic flight; furthermore, the optimal forward sweep angle for sonic boom reduction can be set by adjusting the forward sweep angle in order to obtain the optimal lift equivalent cross-sectional area distribution in the axial direction of the aircraft body during supersonic flight. As a result, both a suppression of sonic booms and a reduction of wave-drag can be achieved.

Furthermore, in the present invention, in the case of flight over water, in which there are almost no restrictions on sonic booms, the wing can be set at the forward sweep angle that provides minimal wave-forming drag, so that a forward sweep angle that is concentrated on the improvement of cruise performance can be set.

Moreover, in regard to the increase in the trim drag that is accompanied by the rearward movement of the aerodynamic center during supersonic flight in case of usual fixed wing airplane, the effect of this movement can be canceled by increasing the forward sweep angle of the main wing so that the aerodynamic center is moved forward; as a result, the trim drag can be minimized.

### BRIEF DESCRIPTION OF THE DRAWINGS

FIG. 1 is a diagram showing how a forward swept wing body and a rearward swept wing body are cut by the Mach plane;

FIG. 2 is a diagram showing the cross-sectional area and lift equivalent cross-sectional area cut by the Mach plane, and also showing the distribution of the equivalent cross-sectional area in the axial direction of the aircraft body;

FIG. 3 is a diagram showing how a forward swept wing body and a rearward swept wing body are cut by the Mach cone;

FIG. 4 is a diagram showing the cross-sectional area and lift equivalent cross-sectional area cut by the Mach cone, and also showing the distribution of the equivalent cross-sectional area in the axial direction of the aircraft body;

FIG. 5 is a diagram showing the body conditions of a forward swept wing configuration and an ordinary configuration cut by the Mach plane perpendicular to the horizontal plane;

FIG. 6 is a diagram showing the cross-sectional area distribution in a case using a variable forward swept wing comparing with ordinary configuration;

FIG. 7 is a diagram showing the mechanism that alters the forward sweep angle of the variable parts of the main wing between supersonic flight and takeoff and landing or subsonic flight;

FIG. 8 is a partial enlargement of the main wing driving mechanism part shown in FIG. 7;

FIG. 9 is a diagram illustrating the disposition and operation of the movable control wing surfaces of the movable parts of the main wing;

FIG. 10 is a plan view showing a case in which the plan shape of the main wing is designed so that an appropriate equivalent cross-sectional area distribution is obtained during flight;

FIG. 11 is a diagram showing an example of the link mechanism that links left and right with a single actuator so that the left and right main wing movable parts move with left-right symmetry;

FIG. 12 is a diagram illustrating the cross-sectional areas of an actual aircraft and an equivalent symmetrical rotational body;

FIG. 13 is a diagram comparing the cross-sectional area distribution of a Sears-Haack body in which the wave-forming drag force is minimized, and the cross-sectional area of an actual aircraft; and

FIG. 14 is a diagram illustrating the paradox between low sonic boom design and area rule design.

### DESCRIPTION OF THE PREFERRED EMBODIMENTS

The basic concept of the present invention is based on the idea that an aircraft body shape in which the equivalent cross-sectional are based on lift can be increased without increasing the conventional cross-sectional area based on volume can be devised, this idea being supported by the assumption that an increase in the “equivalent cross-sectional area based on lift”, which is one of the elements that determine the equivalent cross-sectional area distribution has no direct effect wave-drag. Specifically, the inventors hit on the idea of providing an aircraft body shape in which a blunt-nosed shape is not used for the aircraft body nose portion, where the wave-drag is large, and in which low-boom characteristics are instead realized by using a variable forward swept wing configuration and advancing the sweep angle of the main wing during supersonic flight, so that cross section area based on lift moved forward and wave-drag is also minimized by ensuring a large slenderness ratio in order to minimize wave-forming drag, and maintaining the cross-sectional area distribution of a Sears-Haack body.

The present invention provides a variable forward swept wing configuration which allows the design of a supersonic aircraft that achieves both sonic boom suppression and a reduction of wave-forming drag, so that this aircraft combines economy and environmental compatibility. In order to improve the economy of a supersonic aircraft, it is necessary to reduce the drag of the aircraft body and increase the lift/drag ratio; increasing the slenderness ratio of the equivalent axisymmetrical body and further designing the overall aircraft body shape by area rule design have been proposed as methods for minimizing wave-forming drag.

Meanwhile, when an aircraft flies at supersonic speeds, the shock waves generated from various parts of the aircraft body reach the ground after being adjusted and unified while being propagated through the atmosphere, and are observed as a pressure fluctuation called a sonic boom. It is said that the sonic boom of the Concorde, which is a typical supersonic passenger aircraft, is a sound that is roughly equivalent to that of a nearby lightning strike. Since supersonic flight over land is prohibited by noise problems arising from sonic booms, this is a problem in terms of the practical adaptation of supersonic passenger aircraft. In order to reduce the intensity of sonic booms over land, a method has been proposed in which the unification of shock waves during propagation through the atmosphere is suppressed, so that the sonic boom is caused to reach the ground as a low sonic boom pressure signature that is not an N type waveform. Since shock waves have the property of propagating through air more rapidly as the pressure distribution is larger, it is claimed that it is necessary to generate an intense shock wave at airplane nose by making the aircraft body shape a blunt-nosed shape, and weakening the following shock waves.

However, such a blunt-nosed aircraft body design cannot fulfill the requirements of the abovementioned area rule design, so that an increase in the wave-drag force is unavoidable. The aircraft equivalent cross-sectional area distribution for forming a low sonic boom pressure waveform shown in the abovementioned paper of George and Seebass also indicates that the aircraft body has a blunt nose, and a design method relaxing the bluntness of the aircraft nose shape according to Darden (Darden, C. M., “Sonic-Boom Minimization With Nose-Bluntness Relaxation”, NASA TP-1348, 1979.) can reduce the wave-forming drag force although the sonic boom intensity is slightly increased. However, there is a tradeoff between sonic boom and wave-drag force, so that there is a resulting deterioration in one or both effects.

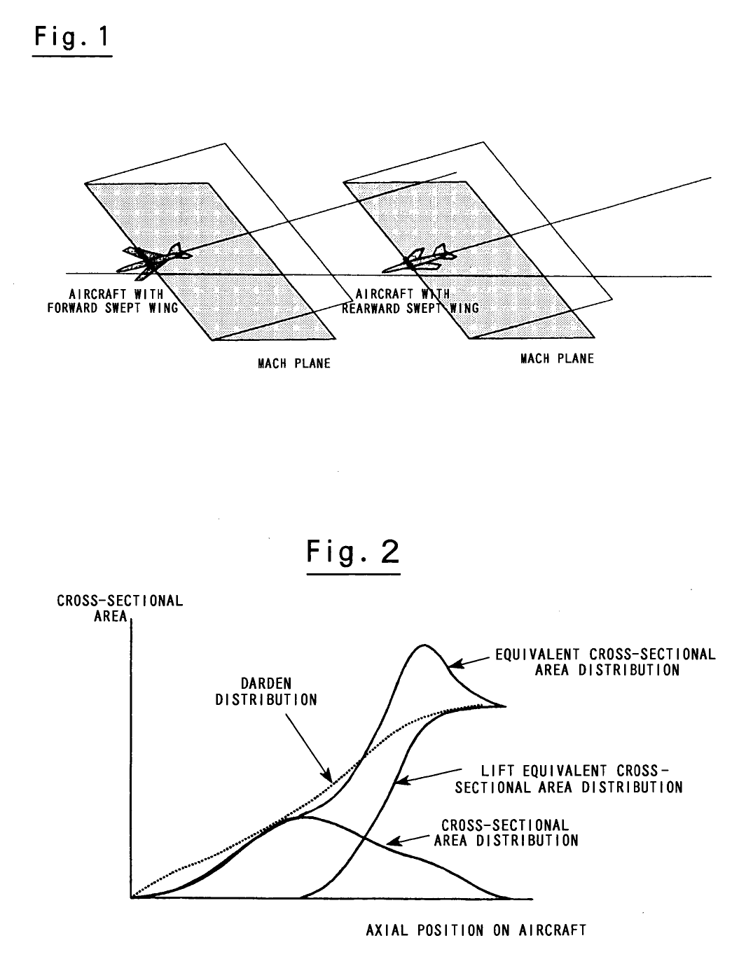

The equivalent cross-sectional area distribution proposed by Darden is composed with two elements (i.e., the sum) of the cross-sectional area distribution obtained by cutting the aircraft body by the Mach plane, and the lift equivalent cross-sectional area distribution depending on the generation of lift. FIG. 1 shows the conditions of the aircraft body cut by the Mach plane; this figure shows (in a schematic diagram) that if a comparison is made in terms of the Mach plane taken at the same fuselage position, lift is generated from a more forward position in the case of the forward swept wing configuration than in the case of the rearward swept wing configuration. FIG. 2 shows the cross-sectional area based on volume cut by the Mach plane, the lift equivalent cross-sectional area based on the lift, and the distribution of the equivalent cross-sectional area in the axial direction of the aircraft body determined as the sum of these two cross-sectional areas. This figure indicates that the equivalent cross-sectional area distribution of an actual supersonic aircraft is insufficient compared to the Darden distribution for realizing low boom characteristics in the forward half of the aircraft body, and exceeds this Darden distribution in the rear half of the aircraft body. It is optimal from the standpoint of low boom theory that there should be certain amount of cross-sectional area distribution in the forward half of the aircraft body as well; however, as is shown in this FIG. 2, the lift equivalent cross-sectional area is in all cases generated in the rear portion of the aircraft axis. In order to compensate for this and adjust the equivalent cross-sectional area distribution to an appropriate size in the forward half, the basic concept of a low boom shape in the past has involved increasing the cross-sectional area based on volume by blunting the nose portion of the aircraft body. However, this method tends to invite an increase in wave-drag, so that it has been difficult to achieve both low boom and low drag characteristics.

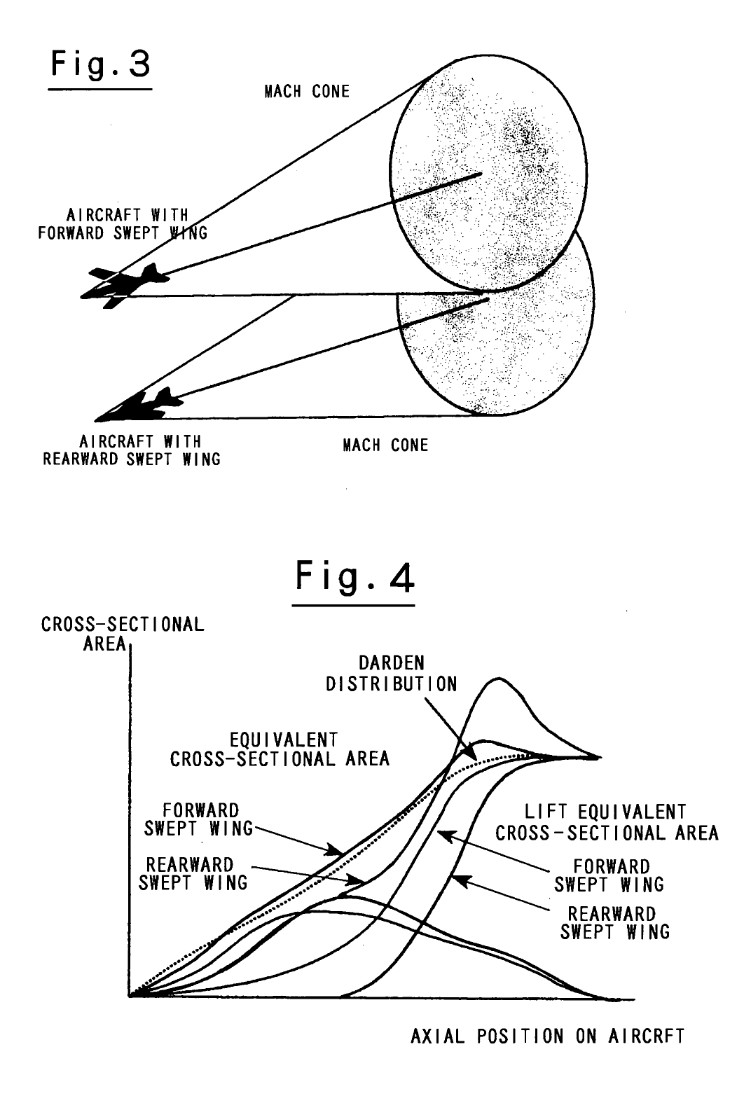

In the present invention, an increase in the equivalent cross-sectional area is made possible in the forward half of the aircraft body by causing the distribution of the lift equivalent cross-sectional area (which has little direct effect on wave-drag) along the forward part of the aircraft axis instead of increasing the volume of the nose portion of the aircraft body; the basic approach is to achieve both low wave-drag and low boom characteristics while avoiding blunting of the nose portion of the aircraft body. It may also be intuitively predicted that the forward swept wing configuration is a convenient configuration for realizing this object; here, FIG. 4 shows the lift equivalent cross-sectional area and the distribution of the equivalent cross-sectional area in the axial direction of the aircraft body in a cases where the aircraft body is cut by the Mach cone which has an apex on the axis of the aircraft body shown in FIG. 3. It is seen here that an increase in the lift-dependent equivalent cross-sectional area distribution in the forward half of the aircraft body is more possible in the case of the forward swept wing configuration than in the case of the rearward swept wing configuration. In FIG. 1, the conditions in a case where the aircraft body is cut by the Mach plane are shown; FIG. 3, on the other hand, shows the conditions in a case where the aircraft body is cut by the Mach cone. As is seen in FIG. 1 as well, the generation of lift from the forward positions of the aircraft body is displayed more conspicuously in the case of the forward swept wing configuration than in the case of the rearward swept wing configuration. In the linear theory of Darden, the equivalent cross-sectional area distribution is determined using the lift distribution in a case where the aircraft body is cut by the downward oriented Mach plane, and in this method, the tendency toward improvement is more relaxed than in cases where the aircraft body is cut by the Mach cone; however, in this case as well, the lift distribution can be pushed forward by the forward swept wing configuration. It is seen from FIG. 4 that a more Darden-like distribution is approached in the case of the forward swept wing configuration than in the case of the rearward swept wing configuration.

The equivalent cross-sectional area distribution that allows low boom characteristics as proposed by Darden fluctuates according to the flight altitude, speed and aircraft body weight; ideally, therefore, it is desirable to realize the optimal distribution for the flight conditions at the time. In the method in which the forward half of the fuselage is blunted, low boom characteristics are basically possible in a single flight state; however, it is difficult to alter the shape of this portion in accordance with the flight conditions. In the case of a variable forward swept wing, the wing can be varied to the optimal forward sweep angle in accordance with the flight conditions, and the angle of the movable control wing surfaces installed on the front and rear edges of the main wing can be varied, thus varying the distribution of the lift and intensity of the shock wave in the wing spanwise direction in addition to the area distribution of the wing in a plan view, so that the equivalent cross-sectional area can be adjusted to a value that is close to the optimal value. This capacity makes it possible to achieve optimal economy by setting the forward sweep angle at a value that achieves both low boom characteristics and low drag in the case of supersonic flight over land, and setting the forward sweep angle in a position dedicate to reduce wave-drag in the case of flight over water where almost no requirements exists to reduce sonic booms.

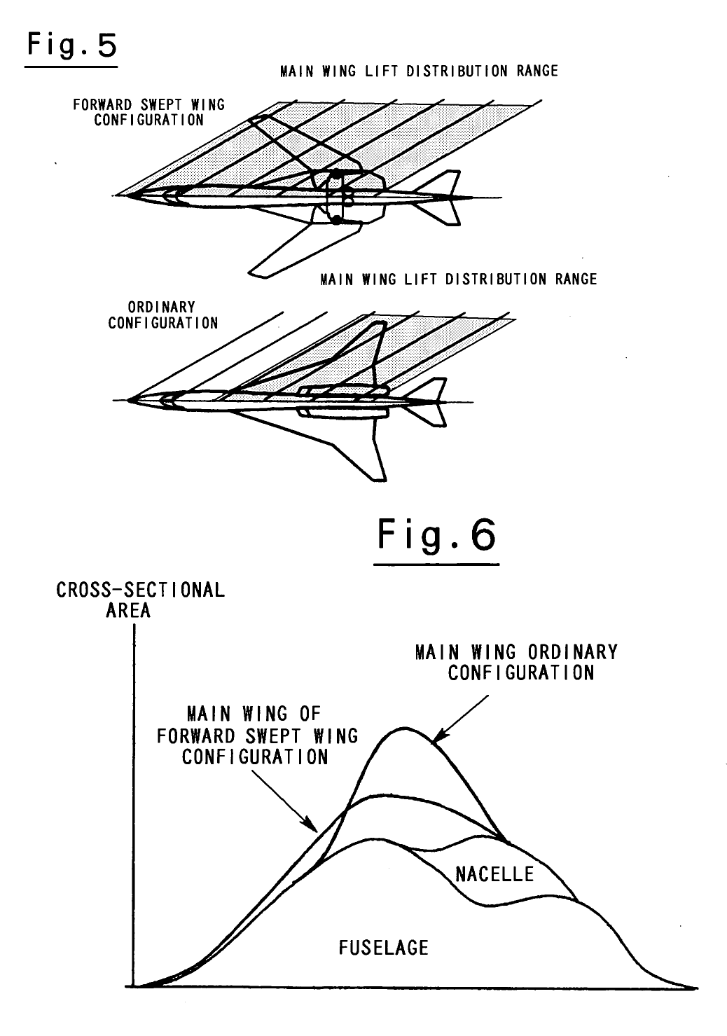

FIG. 5 shows the conditions of the aircraft body cut by the Mach plane perpendicular to the horizontal plane; this figures shows how lift is generated from more forward positions on the aircraft body in the case of the forward swept wing configuration than in the case of the rearward swept wing configuration. In order to reduce wave-drag, it is necessary to apply the so-called area rule. Here, when the distribution of the cross-sectional area is determined, the aircraft body is cut annularly by the Mach plane corresponding to the flight Mach, this plane is rotated about the axis of the aircraft body, and the mean value of cross section areas on each Mach plane is taken; however, as is shown in FIG. 5, in cases where this is taken as the Mach plane perpendicular to the horizontal plane, it is seen that the main wing portion is already counted from the vicinity of the aircraft body nose, that the peak value of the cross-sectional area of the main wing portion is smaller than ordinary wing, and that this distribution region is also stretched in the axial direction of the aircraft body, so that there is an effect on the reduction of wave-drag. FIG. 6 is a schematic diagram showing the cross-sectional area distribution in a case where a variable forward swept wing configuration is used. Compared to an ordinary rearward swept wing configuration or delta wing configuration, the cross-sectional area distribution based on the volume of the aircraft body with a variable forward swept wing configuration shows a smaller peak value of the cross-sectional area distribution, and it is shown that the distribution is stretched forward. The forward movement of this cross-sectional area distribution is small in terms of the amount of the cross-sectional area, therefore, do not increase the wave-drag.

It is seen from the above that the use of a variable forward swept wing which make it possible to achieve low-boom and low drag characteristics at super sonic flight, also makes it possible to reduce the forward sweep angle of the main wing during takeoff and landing, so that the maximum lift of the main wing that is required in order to achieve a favorable takeoff and landing performance can be designed as a large value, and that as a result, the required main wing area can be designed as a small value. However, in cases where the supersonic flight stage is completed, and the aircraft has approached to its destination and reduced the forward sweep angle in preparation for landing, if there is a malfunction in the driving mechanism, the lift at this forward sweep angle is greatly insufficient for landing, and the airplane control and stability is also insufficient for landing, so that there is a possibility that the aircraft will be placed in a dangerous state. Since flight safety is an essential prerequisite for an aircraft, the mechanism used to vary the forward sweep angle must be highly reliable. It is desirable that a mechanism be provided which makes it possible to reduce the forward sweep angle so that the necessary lift can be obtained even if by some chance some malfunction should occur. In the present invention, therefore, a clutch mechanism is provided which makes it possible to release the malfunctioning driving mechanism, and a mechanism is proposed which is such that the main wing is spontaneously caused to return in the direction that reduces the forward sweep angle by the aerodynamic drag generated by the main wing. This safety mechanism is a function that is only possible in the case of a variable forward swept wing configuration; in the case of a variable rearward swept wing configuration, even if a clutch mechanism is employed, aerodynamic drag causes the main wing to move in a direction that further increases the rearward sweep angle.

Furthermore, in the case of ordinary civil aircraft, the provision of a mechanism that mechanically links the left and right so that there is no asymmetrical operation on the left and right of the flaps is required as an airworthiness regulation for civil aircraft. There are no examples of use of main wing configurations involving variable rearward swept wings in civil aircraft, and in the case of examples used in military aircraft, the left-right linkage mechanism safety standards required in civil aircraft are lacking, so that there are no examples of the use of such a mechanism. In regard to the variable forward swept wing configuration of the present invention, there are no examples of use in either military or civil aircraft; however, this configuration was conceived with use in civil aircraft as a prerequisite, so that the use of a left-right connecting mechanism as determined by airworthiness regulation is naturally obligatory. In conventional civil aircraft, the main wing is fixed, so that a mechanism that links the left and right flaps can easily be installed; however, in the case of a variable forward swept wing, since the main wing rotates with respect to the fuselage, a flexible shaft or equivalent flexible linking mechanism that connects the left and right flaps without impeding this movement is required.

During supersonic flight, the wave-drag generated by the main wing can be reduced by increasing the forward sweep angle of the main wing, so that the wave-drag during supersonic flight can be further reduced by using this in combination with a small main wing area originally designed from variable sweep wing concept. Likewise, in regard to the trim drag that is accompanied by the aerodynamic movement of the aerodynamic center toward the rear during supersonic flight, the aerodynamic center can be caused to advance geometrically by advancing the main wing itself, so that on the whole, the movement of the aerodynamic center is canceled, thus minimizing the trim drag. In regard to this effect, the problem is solved in the case of the Concorde by shifting fuel to the rear; in the case of the F14, an American variable rearward swept wing fighter aircraft, small aerodynamic vanes airfoils accommodated in the front of the main wing are extended, thus corresponding to an effect equal to the need to reduce the trim drag during supersonic flight, and producing an effect in reducing the overall trim of the aircraft during supersonic flight.

### EXAMPLES

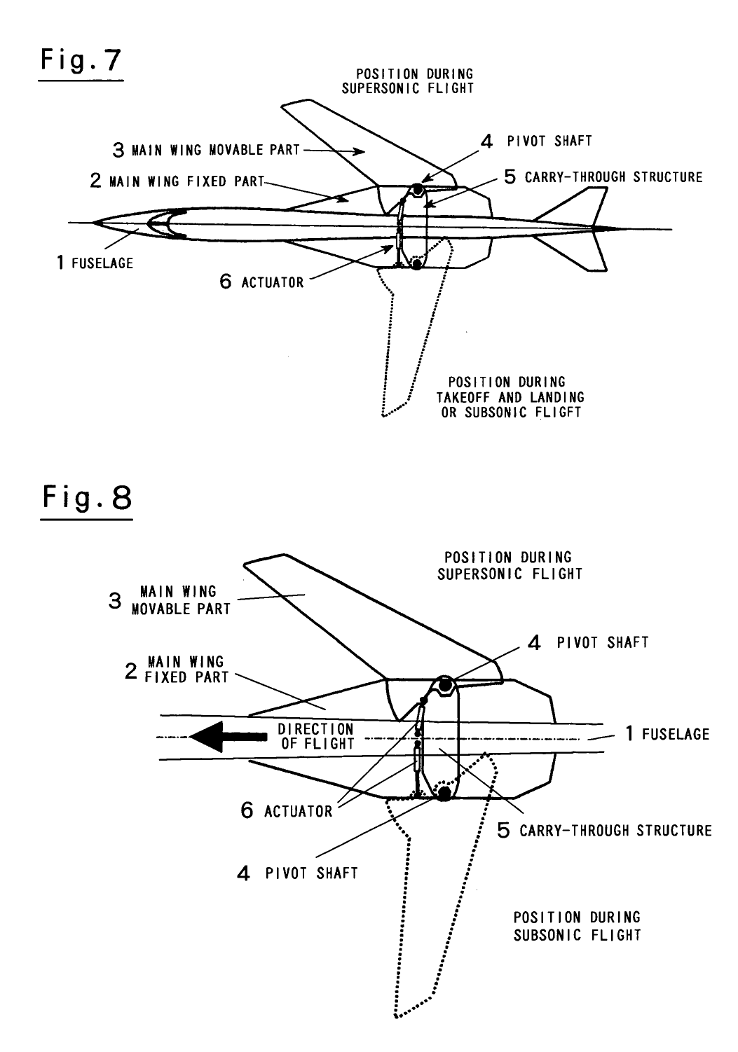

FIG. 7 shows an example of application of the present invention in a plan view. This figure shows the basic concept of the variable forward swept wing configuration that is proposed in order to manifest optimal performance according to respective flight conditions: namely, during takeoff and landing and subsonic flight, the forward sweep angle of the main wing is set at a small value as indicated by the broken line on the side of the left wing, while during supersonic flight, the angle is set at a large value as indicated by the solid line on the side of the right wing, so that sonic booms during supersonic flight are reduced. Each of the left and right main wings is constructed from a main wing fixed part 2 constituting the inside portion, and a main wing movable part 3 constituting the outside portion. The left and right main wing movable parts 3 are connected to the fuselage 1 or the main wing fixed parts 2 protruding from the fuselage via pivot shafts 4 in the vicinity of the main wing roots, and a mechanism is provided in which the end parts are pushed or pulled and driven by actuators that generate a moment in the main wing movable parts 3, so that the forward sweep angle can be varied.

As is shown in a partial enlargement in FIG. 8, this driving mechanism for the main wing movable parts 3 is a variable forward swept wing mechanism which has pivot shafts 4 on the left and right end parts of a carry-through structure 5 that extends through the fuselage 1 and the main wing fixed parts 2 that extend from the fuselage 1, and at the attachment roots of the left and right main wing movable parts 3, a connection is made with the carry-through structure via this pivot mechanism; furthermore, at the front or back of the carry-through structure, the wing end parts of the movable parts 3 of the main wing and the actuators 6 are connected via rods, and the forward sweep angle of the main wing is varied by the driving of these actuators 6 that push and pull the abovementioned wing end parts.

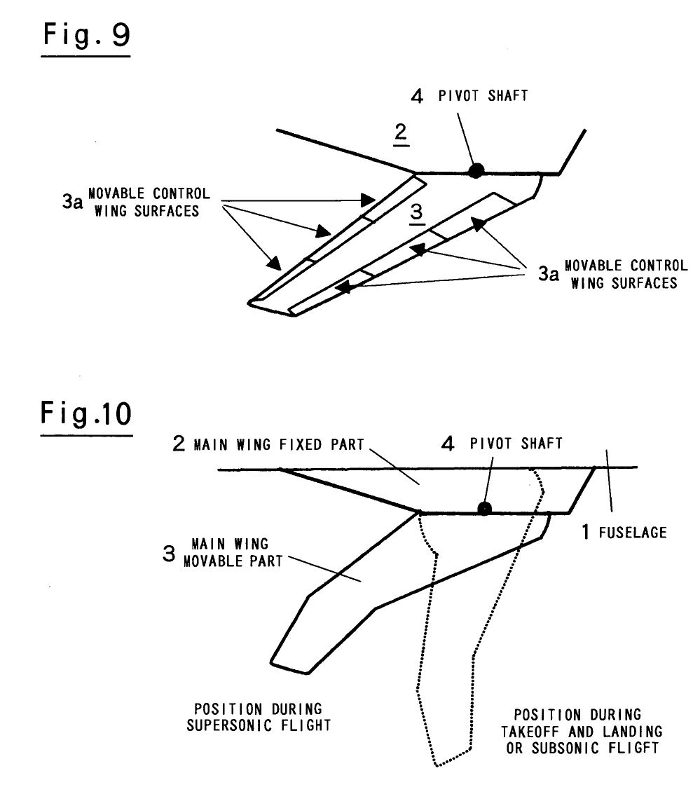

FIG. 9 is a plan view of an example of application of the present invention; this figure shows an example which is devised so that movable control wing surfaces 3a are present not only on the rear edge parts, but also on the front edge parts, of the main wing movable parts 3 that make it possible to vary the forward sweep angle. Here, the lift distribution in the direction of spanwise location of the wings is adjusted by varying the deflection angle of each of these control wing surfaces 3a independently in accordance with the variation in the forward sweep angle, so that an equivalent cross-sectional area distribution that is ideal for the realization of low boom characteristics can be obtained. These movable control wing surfaces 3a are generally called flaps, and have the object of increasing the lift of the main wing as a result of the front or rear edge parts of the main wing constructed from mechanical hinge parts or flexible outer plates that form an integral unit with the wing being operated by actuators in the direction that lowers the angle of these parts with respect to the main wing. The control wing surfaces 3a of the present invention also operate on the same basic principle; however, the object of these control wing surfaces is to adjust the lift distribution in the wing spanwise direction of the main wing during supersonic flight in order to obtain distribution that is optimal for low boom characteristics. Accordingly, it is not always the case that these flaps are lowered in order to increase the lift; portions that reduce the lift by raising the flaps above the main wing are also envisioned, and these flaps also have the function of adjusting the angle of the front edge parts and rear edge parts according to the position in the wing spanwise direction of the main wing.

FIG. 10 shows a plan view of an example in which the plan view shape of the main wing is designed so that an optimal equivalent cross-sectional area distribution is obtained beforehand in the flight state of the aircraft. This main wing consists of fixed parts 2 that are fastened to the fuselage 1, and movable parts 3 that are connected to these fixed parts 2, and is devised so that the abovementioned main wing fixed parts 2 have the basic configuration of a substantially triangular wing. The abovementioned main wing movable parts 3 have a structure in which the tip end portions are bent rearward, and the forward sweep angle of these main wing movable parts 3 can be variably adjusted via a pivot mechanism. In this example, the base parts of the main wing movable parts 3 are formed with a circular arc shape at both the front edges and rear edges in order to obtain a smooth connecting structure between the main wing fixed parts 2 and main wing movable parts 3. In the forward swept wing configuration, the front edges of the main wing movable parts 3 are accommodated inside the main wing fixed parts 2, while during takeoff and landing and subsonic flight, the rear edges are accommodated inside the main wing fixed parts 2.

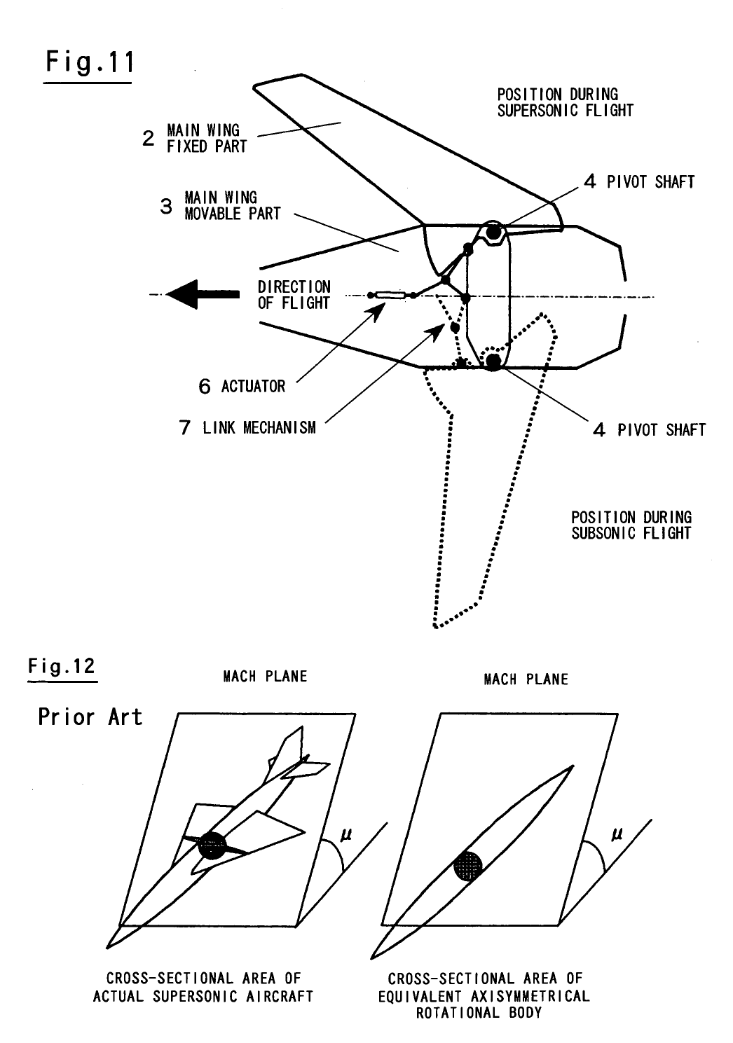

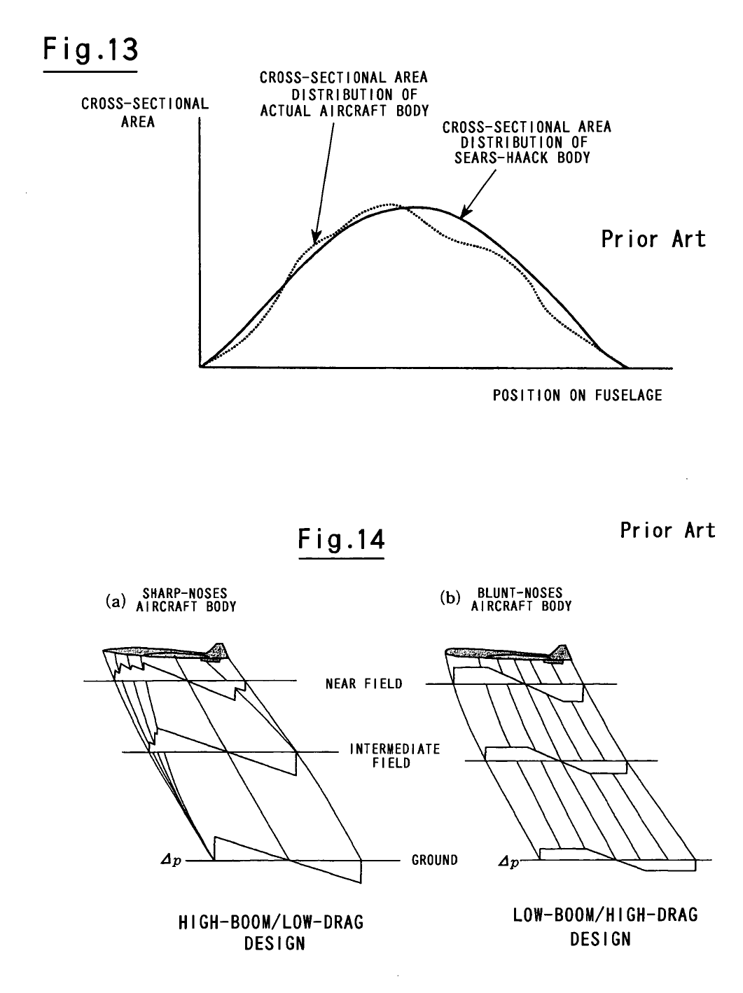

FIG. 11 is a plan view of an example of application of the present invention; here, it is presupposed that the left and right main wing movable parts 3 move with left-right symmetry; accordingly, a layout is shown in which the forward sweep angles of the left and right main wings are simultaneously driven by a single actuator 6 and a linking mechanism 7 that links the left and right. Furthermore, in regard to the movable control wing surfaces 3a (generally called flaps) as well, it is required that the left and right lift be balanced during takeoff and landing; accordingly, in the present invention, a mechanism (not shown in the figures) that links the corresponding left and right control wing surfaces to each other is provided, so that the left and right high lift devices are prevented from operating asymmetrically.

The Concorde, which was the only supersonic civil transport airplane ever built, was retired from service in October of 2003, so that that there is now no supersonic aircraft in service as a civil transport aircraft. There are currently no prospects for the development of a real supersonic aircraft of the next generation as a successor to the Concorde (with a seating capacity of 250 to 300 seats); however, as a preliminary stage, research on a supersonic business jet (SSBJ) with a seating capacity of approximately 8 to 10 seats, and a small SST with a seating capacity of approximately 20 to 30 seats, is being pursued by NASA in the U.S.A. and business jet manufacturers, and research on aircraft body shapes that achieve both economy and environmental compatibility is currently active. If these goals are achieved, there is a great possibility that the development of an SSBJ or small SST will become a reality.

1. A supersonic aircraft comprising a mechanism that allows variable adjustment of the forward sweep angle as the main wing configuration, wherein both the suppression of sonic booms and the reduction of wave-drag are achieved by advancing the main wing during supersonic flight so that the lift equivalent cross-sectional area distribution is varied.

2. The supersonic aircraft according to claim 1, comprising means for accumulating as data sonic boom theoretical solutions that fluctuate according to the airspeed, altitude and body weight of the aircraft, and calculating the forward sweep angle that approaches the optimal equivalent cross-sectional area distribution from airspeed and altitude information during flight.

3. The supersonic aircraft according to claim 1, wherein the lift equivalent cross-sectional area distribution is adjusted on the basis of information relating to the forward sweep angle of the aircraft and the deflection angle of the movable control wing surfaces of the main wing, so that an equivalent cross-sectional area distribution that is optimal for the flight conditions of supersonic flight is obtained.

4. The supersonic aircraft according to claim 1, wherein the main wing consists of fixed parts that are fastened to the fuselage, and movable parts that are connected to these fixed parts, said main wing fixed parts have the basic shape of a substantially triangular wing, said main wing movable parts have a structure in which the tip end is bent toward the rear, and the forward sweep angle of said main wing movable parts is variably adjustable.

5. The supersonic aircraft according to claim 2, wherein the main wing consists of fixed parts that are fastened to the fuselage, and movable parts that are connected to these fixed parts, said main wing fixed parts have the basic shape of a substantially triangular wing, said main wing movable parts have a structure in which the tip end is bent toward the rear, and the forward sweep angle of said main wing movable parts is variably adjustable.

6. The supersonic aircraft according to claim 3, wherein the main wing consists of fixed parts that are fastened to the fuselage, and movable parts that are connected to these fixed parts, said main wing fixed parts have the basic shape of a substantially triangular wing, said main wing movable parts have a structure in which the tip end is bent toward the rear, and the forward sweep angle of said main wing movable parts is variably adjustable.

7. The supersonic aircraft according to claim 1, wherein pivot shafts are disposed in the left and right main wing fixed parts in order to vary the forward sweep angle of the main wing of the aircraft in supersonic flight, the left and right main wing movable parts are connected so as to rotate about said shafts, and has a driving mechanism that can push and pull the end parts of said main wing movable parts, and the forward sweep angle of the main wing is varied by the operation of this mechanism.

8. The supersonic aircraft according to claim 2, wherein pivot shafts are disposed in the left and right main wing fixed parts in order to vary the forward sweep angle of the main wing of the aircraft in supersonic flight, the left and right main wing movable parts are connected so as to rotate about said shafts, and has a driving mechanism that can push and pull the end parts of said main wing movable parts, and the forward sweep angle of the main wing is varied by the operation of this mechanism.

9. The supersonic aircraft according to claim 3, wherein pivot shafts are disposed in the left and right main wing fixed parts in order to vary the forward sweep angle of the main wing of the aircraft in supersonic flight, the left and right main wing movable parts are connected so as to rotate about said shafts, and has a driving mechanism that can push and pull the end parts of said main wing movable parts, and the forward sweep angle of the main wing is varied by the operation of this mechanism.

10. The supersonic aircraft according to claim 4, wherein pivot shafts are disposed in the left and right main wing fixed parts in order to vary the forward sweep angle of the main wing of the aircraft in supersonic flight, the left and right main wing movable parts are connected so as to rotate about said shafts, and has a driving mechanism that can push and pull the end parts of said main wing movable parts, and the forward sweep angle of the main wing is varied by the operation of this mechanism.

11. The supersonic aircraft according to claim 7, further comprising a single driving actuator and a linking mechanism that links the left and right main wing movable parts in order to drive the left and right parts simultaneously and symmetrically.

12. The supersonic aircraft according to claim 7, further comprising a clutch interposed in a mechanism between the driving mechanism and the end parts of the main wing movable parts, and having a function capable of, in cases where said driving device malfunctions, reducing the forward sweep angle spontaneously and setting the angle at a forward sweep angle that is suitable for takeoff or landing by the aerodynamic drag generated on the main wing when said clutch is disengaged.

13. The supersonic aircraft according to claim 11, further comprising a clutch interposed in a mechanism between the driving mechanism and the end parts of the main wing movable parts, and having a function capable of, in cases where said driving device malfunctions, reducing the forward sweep angle spontaneously and setting the angle at a forward sweep angle that is suitable for takeoff or landing by the aerodynamic drag generated on the main wing when said clutch is disengaged.

14. The supersonic aircraft according to claim 7, further comprising left and right connecting mechanisms installed on the movable control wing surfaces of the main wing, and having a function of causing left and right high lift devices not to operate asymmetrically during takeoff or landing, this function being maintained even if the forward sweep angle varies.

15. The supersonic aircraft according to claim 11, further comprising left and right connecting mechanisms installed on the movable control wing surfaces of the main wing, and having a function of causing left and right high lift devices not to operate asymmetrically during takeoff or landing, this function being maintained even if the forward sweep angle varies.
